(19) United States
(12) Patent Application Publication
(10) Pub. No.: US 2006/0184891 A1
(43) Pub. Date: Aug. 17, 2006

(54) Simplified interactive graphical user interfaces for display systems by removal of inactive windows after a time-out period

(76) Inventors: Jason Michael Parker, San Antonio, TX (US); Herman Rodriguez, Austin, TX (US)

Correspondence Address: IBM CORPORATION;INTELLECTUAL PROPERTY LAW, 11400 BURNET ROAD, AUSTIN, TX, 78758, US

(21) Appl. No.: 11/060,607

(22) Filed: Feb. 17, 2005

(51) Int. Cl. G06F 9/00

(52) U.S. Cl. 715/767; 715/803; 715/768; 715/811

(57) ABSTRACT

A user friendly display interface system for simplifying the user interactive display interface through removal of inactive windows comprising the combination of an implementation for determining whether each of said plurality of windows is active, an implementation for presetting an initial time period for which each of said plurality of windows may remain inactive and means responsive to the end of said initial time period for each of the plurality of windows for commencing a time-out period for each of the plurality of windows. There is a display indicator for the progress of this time-out period towards termination for any windows, together with an implementation for each of the plurality of windows for closing said window upon termination of its time-out period. There is also a user interactive implementation for restoring any of the plurality of windows to active during said time-out period.

### TECHNICAL FIELD

The present invention relates to user interactive computer supported display technology and particularly to windows-type graphical user interfaces crowded with a variety of windows, often in stacks of overlapped windows.

### BACKGROUND ART

The past decade has been marked by a technological revolution driven by the convergence of the data processing industry with the consumer electronics industry. This advance has been even further accelerated by the extensive consumer and business involvement in the Internet or World Wide Web (Web) (used interchangeably). As a result of these changes, it seems as if virtually all aspects of human endeavor in the industrialized world require human-computer interfaces. There is a need to make computer directed activities accessible to a substantial portion of the world's population, which, up to a few years ago, was computer indifferent. In order for the vast computer supported marketplaces to continue and be commercially productive, it will be necessary for a large segment of computer indifferent consumers to be involved in computer interfaces.

With the increasing power of computers, functions and resources available to the interactive user have greatly increased. However, along with this increase in function has come a significant increase in the number and variety of windows available to the user in a display screen interface. This, of course, makes the interface much more complex with tens, potentially hundreds, of available windows that contain the interactive data items, such as icons. These are arranged in stacks of overlapping windows, the display of which is controlled and tracked through a multi-tiered display or frame buffer, such as the depth buffers described in U.S. Pat. No. 5,241,656.

In fact, the multi-tiered hierarchy of windows has become so extensive that they often are arranged in a plurality of desktop session levels. A desktop session is usually made up of several layers of overlapping windows that the depth frame buffer indexes and tracks. In addition, window interfaces are set up to handle additional desktop sessions of layered windows that are inactive and stored outside of the frame buffer, but may be interactively moved into and out of the frame buffer as the sessions are activated. With such a complex arrangement, it will be obvious that at any given time a desktop display interface will present a confusion of many windows, particularly to users with limited computer experience.

When windowing environments were originally developed, the interactive user had to deal with no more than a handful of windows. From that time on, it became customary to identify each window with a title bar including the name or title of the window. With so few windows, even if there was some overlap, it was simple for the user to shift a window with his cursor so as to expose the title bar and identify the window. At the present time, with the number and the complicated hierarchies of windows described above, it is often a tedious and difficult task for the user to shift or drag the displayed windows to expose enough of the title bars or even other portions of windows sufficient to identify partially covered windows that are active.

It has been recognized that it would be desirable to simplify such complex display interfaces by eliminating windows that are inactive. It is not unusual for users to open windows, then jump from one window to another without closing and then forget about windows no longer needed by the user. Thus, the art is seeking implementations that eliminate or remove inactive windows. However, in order for such implementations to be effective, the removal of an inactive window must be brought to the user's attention. Otherwise, the user may lose from the display interface, a window that he intended to keep active but has overlooked.

### SUMMARY OF THE PRESENT INVENTION

The present invention offers an implementation to simplify GUI display interfaces through the removal of inactive windows that gives appropriate warning of such removal to the user such that there will be ease of use for even the unsophisticated computer user. The invention provides a user friendly display interface system for simplifying the user interactive display interface through removal of inactive windows comprising the combination of means for determining whether each of said plurality of windows is active, means for presetting an initial time period for which each of said plurality of windows may remain inactive, means responsive to the end of said initial time period for each of said plurality of windows for commencing a time-out period for each of said plurality of windows, displayed means for indicating the progress of said time-out period towards termination for each of said windows, means for each of said plurality of windows for closing said window upon termination of its time-out period and user interactive means for restoring each of said plurality of windows to active during said time-out period. The windows being handled may be in the customary window stacks of wholly or partially hidden windows.

The displayed means for indicating the progress of the time-out are preferably the fade-out of the window toward total transparence during said time-out period. However, such indicating means may also be changing color in the window as the time-out progresses or diminishing the size of the window as the time-out progresses. It should also be noted that a user may be enabled to set different time-out periods for each of said plurality of windows.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of an interactive data processor controlled display system including a central processing unit that is capable of implementing the elimination of windows of the present invention;

FIG. 2 is a diagrammatic view of a display screen showing a stack of windows in sequences of steps showing both the time-out of an inactive window both to completion without user intervention and the restoration of the inactive window as desired by user during the time-out;

FIG. 3 is a flowchart of the program steps involved in setting up the elimination of an inactive window system of the present invention; and

FIG. 4 is a flowchart of an illustrative running of the steps set up in the program of FIG. 3.

### DETAILED DESCRIPTION OF THE PREFERRED EMBODIMENT

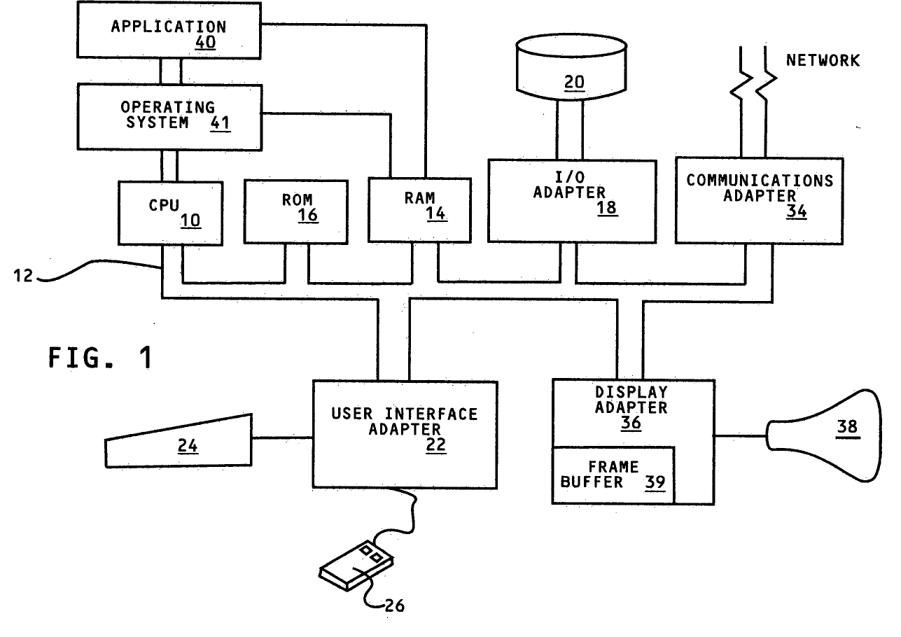

Referring to FIG. 1, a typical data processing system is shown that may function as the computer controlled display terminal used in implementing the system of the present invention of eliminating inactive windows with an indicator when the inactive window is being timed-out. A central processing unit (CPU) 10, such as one of the PC microprocessors or workstations, e.g. RISC System/6000™ series available from International Business Machines Corporation (IBM), or Dell PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs include the programs of the present invention for elimination of inactive windows from an interactive display interface that will be described hereinafter. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside Internet or Web network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. Display adapter 36 includes a frame buffer 39 that is a storage device that holds a representation of each pixel on the display screen 38. Images may be stored in frame buffer 39 for display on monitor 38 through various components, such as a digital to analog converter (not shown) for CRTs and the like for digital displays, e.g. LCD displays. As previously mentioned, in order to accommodate the hierarchies of overlapping and hidden windows, the frame buffer 39 should be a depth buffer, for example the depth buffer of U.S. Pat. No. 5,241,565. By using the aforementioned I/O devices, a user is capable of inputting information to the system through the keyboard 24 or mouse 26 and receiving output information from the system via display 38.

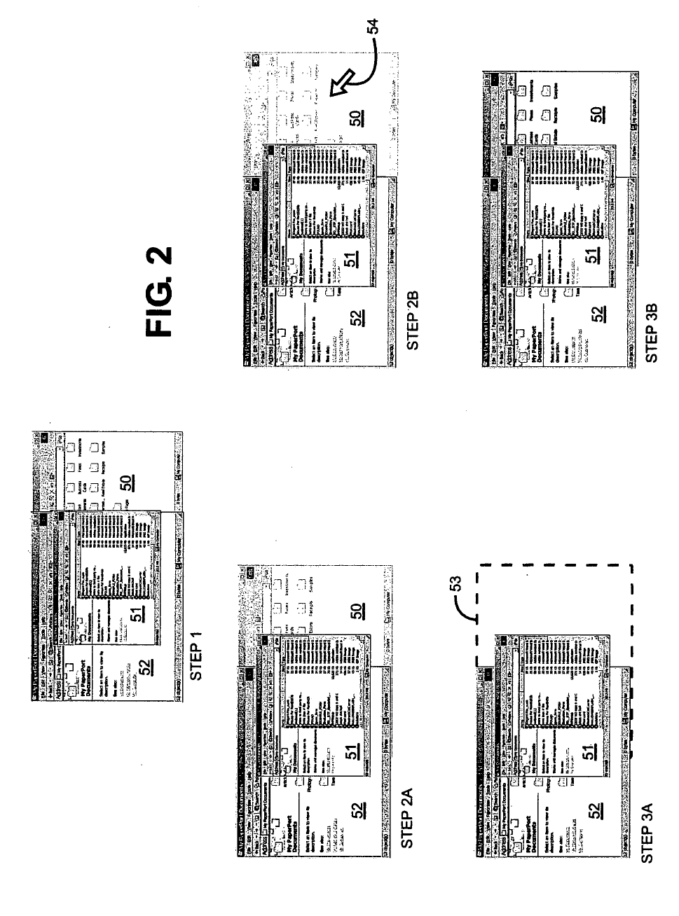

There will now be described a simple illustration of the present invention with respect to the display screens of FIG. 2. A series of comparative steps illustrate an embodiment of the invention. The display interface has been simplified in Step 1 for purpose of illustration to show just three of the multitude of windows usually in such a GUI interface. In this example, windows 51 and 52 have been active while window 50 has been inactive for a period. The permissible period of inactivity has been pre-set. Let us presume that initial period of permitted inactivity, 3 minutes, has run out, and although window 50 is still clearly visible, it is about to commence, its time-out period that has also been pre-set, e.g. 4 minutes. During this time-out period, which is illustrated in Step 2A, the window 50 begins to fade out. Step 3A shows the completion of the time-out and window 50 has completely disappeared from the screen as indicated by dashed line 53. At any time during the fade-out period, the user may point and click, mouse pointer 54, step 2B, within the window and window 50 will be restored to full visibility and activity as shown in step 3B.

It should be noted that other means may be used to eliminate or close the window while visually indicating the timing-out. The time-out window may be shrunk towards elimination. Also, a color change, somewhere within a window, e.g. in the window title bar, may be used to indicate timing out. In addition, the user may readily be enabled to restore all windows removed during a session. Since even the windows removed from the display interface are still tracked in the framed buffer, the user may be offered a simple display screen prompt, “Restore all Windows”, to point and click to restore all removed windows.

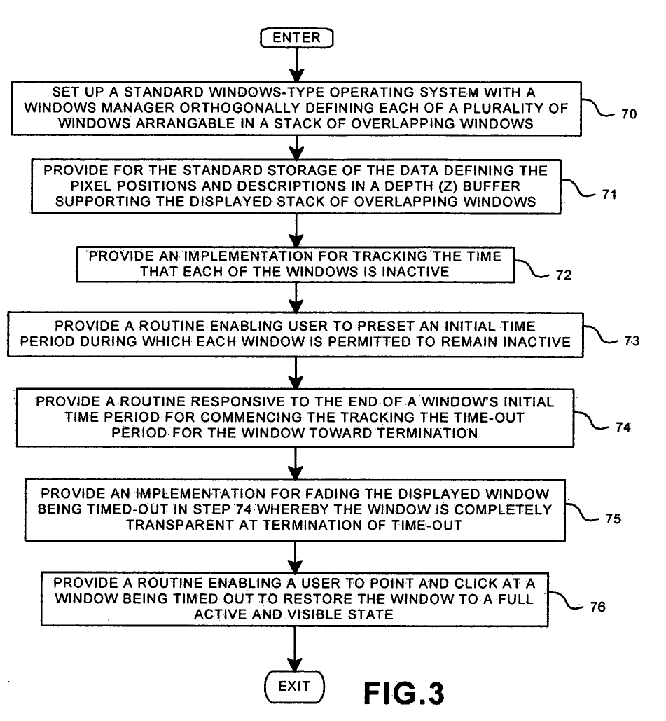

Now, with reference to FIG. 3, we will describe a process implemented by a program according to the present invention for gradually eliminating inactive windows while visually indicating the time-out of the window. The program routines created by the process of FIG. 3 implement the operations described with respect to FIG. 2. In the flowchart of FIG. 7, a basic type of operating system is set up, step 70, using any operating system for managing a hierarchy of windows, e.g. Windows Millennium™, and Motif for Unix or AIX to orthogonally define the overlapping windows in the stack and the positions of the windows in the depth levels of the hierarchy. This is accomplished by standard storage of data defining the pixel descriptions and orthogonal positions in a depth or Z-buffer to support a stack of overlapping windows, step 71. A conventional implementation is provided for tracking the time that each window is inactive, step 72. There is an initial routine provided that enables the user to preset an initial time period during which each of the windows is permitted to remain inactive, step 73. There is also provided a routine responsive to the end of the initial time period of step 73 for commencing the tracking of a time-out period for the window toward termination, step 74. An implementation is provided corresponding to the time-out of step 74 for fading the window being timed out until it is fully transparent, step 75. There is also provided a routine enabling a user to point and click at a window being timed out to fully restore the window in an active state, step 76.

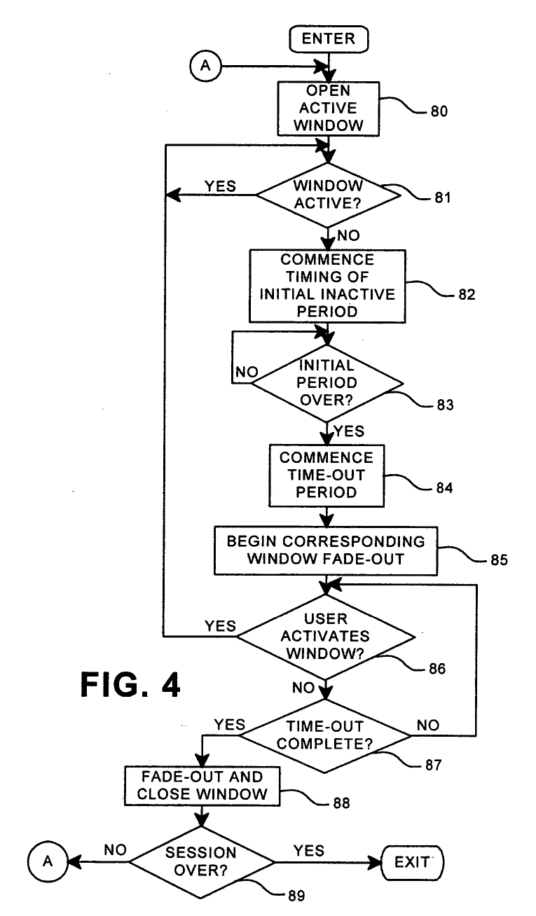

Now that the basic program has been described and illustrated, there will be described with respect to FIG. 4, a simple operation showing how the program could be run. Let us deal with an open window that has been active, step 80. A determination is made, step 81, as to whether the window is still active. If Yes, the active window is permitted to be displayed. If No, the timer timing the initial inactivity period is started, step 82. Then a periodic determination is made, step 83, as to whether the initial period of time is reached. If Yes, the timer timing the time-out period is commenced, step 84, and the fade-out of the window corresponding to the time-out is also started, step 85. A determination is then made during the time-out as to whether the user has activated the window being timed out, step 86. If Yes, then the process is branched back to step 81 wherein the window has been opened and is displayed. If the determination in step 86 is No activation, then a further determination is made, step 87, as to whether the time-out is over. If No, the process is returned to step 86, and the fade-out continues. If Yes, then step 88, the window is faded out and closed. At this point, a determination may be made as to whether the session is over. If Yes, the session is exited. If No, the process is returned to step 80 via branch A.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a computer controlled interactive display system comprising a stored hierarchy of windows that are displayable to form a displayed plurality of user interactive windows, a system for simplifying the user interactive display interface comprising:
means for determining whether each of said plurality of windows is active;
means for presetting an initial time period for which each of said plurality of windows may remain inactive;
means responsive to the end of said initial time period for each of said plurality of windows for commencing a time-out period for each of said plurality of windows;
displayed means for indicating the progress of said time-out period towards termination for each of said windows;
means for each of said plurality of windows for closing said window upon termination of its time-out period; and
user interactive means for restoring each of said plurality of windows to active during said time-out period.

2. The system for displaying windows of claim 1 wherein said stored hierarchy of windows are displayable to overlap each other in a selected order to form a displayed stack of windows.

3. The system for displaying windows of claim 2 wherein said means for indicating the progress of said time-out period for each of said windows fades said window toward total transparence during said time-out period.

4. The system for displaying windows of claim 2 wherein said means for indicating the progress of said time-out period for each of said windows changes color as the time-out period progresses.

5. The system for displaying windows of claim 4 wherein:
each of said plurality of windows has a title bar; and
said means for indicating the progress of said time-out period for each of said windows changes the color of the title bar as the time-out period progresses.

6. The system for displaying windows of claim 2 wherein said means for indicating the progress of said time-out period for each of said windows diminishes the size of the window as the time-out period progresses.

7. The system for displaying windows of claim 2 further including means for enabling the setting of different time-out periods for each of said plurality of windows.

8. In a computer controlled interactive display operations comprising a stored hierarchy of windows that are displayable to form a displayed plurality of user interactive windows, a method for simplifying the user interactive display interface comprising:
determining whether each of said plurality of windows is active;
presetting an initial time period for which each of said plurality of windows may remain inactive;
commencing a time-out period responsive to the end of said initial time period for each of said plurality of windows;
displaying an indication of the progress of said time-out period towards termination for each of said windows;
closing each of said plurality of windows upon termination of its time-out period; and
enabling the user to restore each of said plurality of windows to active during said time-out period.

9. The method of displaying windows of claim 8 wherein said stored hierarchy of windows are displayable to overlap each other in a selected order to form a displayed stack of windows.

10. The method of displaying windows of claim 9 wherein said step of indicating the progress of said time-out period for each of said windows fades said window toward total transparency during said time-out period.

11. The method of displaying windows of claim 9 wherein said step of indicating the progress of said time-out period for each of said windows changes a displayed color as the time-out period progresses.

12. The method of displaying windows of claim 11 wherein:
each of said plurality of windows has a title bar; and
said step of indicating the progress of said time-out period for each of said windows changes the color of the title bar as the time-out period progresses.

13. The method for displaying windows of claim 9 wherein said step of indicating the progress of said time-out period for each of said windows diminishes the size of the window as the time-out period progresses.

14. The method of displaying windows of claim 9 including the further step of enabling the setting of different time-out periods for each of said plurality of windows.

15. A computer program having code recorded on a computer readable medium for simplifying the user interactive display on a display screen in a computer controlled display system comprising a stored hierarchy of windows that are displayable to form a displayed plurality of user interactive windows, comprising:
means for determining whether each of said plurality of windows is active;
means for presetting an initial time period for which each of said plurality of windows may remain inactive;
means responsive to the end of said initial time period for each of said plurality of windows for commencing a time-out period for each of said plurality of windows;
displayed means for indicating the progress of said time-out period towards termination for each of said windows;
means for each of said plurality of windows for closing said window upon termination of its time-out period; and
user interactive means for restoring each of said plurality of windows to active during said time-out period.

16. The computer program for displaying the display of windows of claim 15 wherein said stored hierarchy of windows are displayable to overlap each other in a selected order to form a displayed stack of windows.

17. The computer program for simplifying the display of windows of claim 16 wherein said means for indicating the progress of said time-out period for each of said windows fades said window toward total transparency during said time-out period.

18. The computer program for simplifying the display of windows of claim 16 wherein said means for indicating the progress of said time-out period for each of said windows changes color as the time-out period progresses.

19. The computer program for simplifying the display of windows of claim 18 wherein:
each of said plurality of windows has a title bar; and
said means for indicating the progress of said time-out period for each of said windows changes the color of the title bar as the time-out period progresses.

20. The computer program for simplifying the display of windows of claim 16 wherein said means for indicating the progress of said time-out period for each of said windows diminishes the size of the window as the time-out period progresses.

21. The computer program for simplifying the display of windows of claim 16 further including means for enabling the setting of different time-out periods for each of said plurality of windows.
